(19) United States
(12) Patent Application Publication
(10) Pub. No.: US 2004/0201519 A1
(43) Pub. Date: Oct. 14, 2004

(54) Positioning system, and method for offering positioning information

(76) Inventors: Toshiyuki Aoki, Hitachi (JP); Norihisa Yanagihara, Chiyoda (JP); Satoshi Sugawara, Kimitsu (JP); Toshihide Maeda, Sagamihara (JP); Kenjiro Fujii, Yachiyo (JP); Masahiko Watanabe, Narashiro (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/820,710

(22) Filed: Apr. 9, 2004

(30) Foreign Application Priority Data
Apr. 9, 2003 (JP) 2003-104766

(51) Int. Cl. G01S 5/14

(52) U.S. Cl. 342/357.03; 342/357.09

(57) ABSTRACT

A positioning system offers positioning information on the basis of a signal transmitted from a quasi-zenith satellite. Multiple reference stations disposed on the ground receive signals from a plurality of positioning satellites. A communication station corrects the signals the reference stations have received, and transmits them to the quasi-zenith satellite. A positioning information offering apparatus transmits the signal received from the quasi-zenith satellite and a positional information to a positioning apparatus.

### BACKGROUND OF THE INVENTION

The present invention generally relates to positioning systems using positioning satellite signals, and particularly to a positioning system based on a signal from a quasi-zenith satellite.

A conventional positioning system using satellites is described in the gazette of JP-A-2002-243829. As described in this gazette, a ground station and terminals transmit to satellites the signals including orbit information data and positioning correction information. Then, the terminals receive the orbit information data and positioning correction information sent from the satellites, and compute the positions of the terminals on the basis of the received information.

The gazette of JP-A-2001-124841 describes an example of the GPS receiver that receives correction information of, the GPS satellites from GPS wide-area and enhancing satellites or through FM multiplex broadcasts, and compensates for the positional information of the GPS receiver. Also, JP-A-2001-228232 describes an example of GPS receiver that specifies the position of a stationary satellite, receives the correction information of GPS satellites from the specified stationary satellite and corrects the data associated with the GPS satellites, and another example of GPS receiver that specifies a provider on the basis of the position of the GPS receiver, and determines a stationary-satellite number.

### SUMMARY OF THE INVENTION

Those conventional GPS receivers mentioned above couldn't receive signals of correction information from the satellites because of the effects of the shadows of buildings in urban areas or of mountains in mountain areas. Therefore, the positioning could not be made with high precision. Moreover, for the GPS receivers or positioning system disclosed in JP-A-2002-243829 and JP-A-2001-124841, since the satellites are required to transmit the wide-area correction information to the terminals located nationwide, the amount of data traffic to the terminals increases. For the GPS receiver disclosed in JP-A-2001-228232, a satellite is necessary associated with the provider that offers the correction information to its area.

In view of the above problems with the above prior art, it is an object of the invention to provide a positioning system capable of positioning with high precision in the areas behind the buildings such as urban areas and behind mountains such as mountain areas, and of positioning with high precision over wider areas. It is another object of the invention to provide a positioning system capable of reducing the amount of correction information traffic to positioning apparatus and positioning information offering apparatus, and hence cutting down the apparatus cost. It is still another object of the invention to provide a positioning system capable of decreasing the number of correction-information transmitting satellites in each area.

In order to achieve the above objects, there is provided a positioning system for offering positioning information on the basis of a signal transmitted from a quasi-zenith satellite, wherein this signal includes another signal transmitted to the quasi-zenith satellite from a communication station after being produced as a result of processing still other signals received from a plurality of positioning satellites by multiple reference stations placed on the ground, and a positioning information offering apparatus is provided to transmit the signal sent from the quasi-zenith satellite and its own positioning information.

Preferably, the signal transmitted from the communication station includes at least a signal resulting from processing the signals that three ones surrounding the positioning information offering apparatus, of the multiple reference stations, have transmitted, and the positioning information of the positioning information offering apparatus includes its own identification code, transmitting time, and its own position or position at the time of transmission. In addition, preferably, the frequency of the signal transmitted from the quasi-zenith satellite is different from that of the signal transmitted from the positioning information offering apparatus. Moreover, the signal transmitted from the positioning information offering apparatus is preferably of 2.4-GHz band, 5-GHz band or a frequency band for mobile communication.

In addition, there is provided a positioning system connected via a network to a communication station for offering positioning information, wherein a positioning information offering apparatus is provided to transmit its own positioning information and other positioning information that is offered from the communication station after being produced by processing the signals received from a plurality of positioning satellites by multiple reference stations.

Also, there is provided a positioning system for offering positioning information on the basis of a signal transmitted from a quasi-zenith satellite, wherein this signal includes another signal transmitted to the quasi-zenith satellite after being produced as a result of processing still other signals received at multiple places from a plurality of positioning satellites, and a positioning apparatus is provided to detect its own position by receiving a composite signal from a positioning information offering apparatus that is placed on the ground to combine the signal sent from the quasi-zenith satellite and its own positioning information and to transmit the composite signal.

Further, the multiple positioning satellites may include at least any one of GPS satellite, GLONASS satellite, GALILEO satellite and quasi-zenith satellite. The signal transmitted from the quasi-zenith satellite may have its transmission channel changed according to the reference stations that have received signals from the positioning satellites. In addition, the positioning information offering apparatus may selectively change the receiving channel of the signal transmitted from the quasi-zenith satellite according to the reference stations disposed around the apparatus. Moreover, the signal transmitted from the quasi-zenith satellite may be a signal of which the transmission channel is changed according to the reference stations that have received the signals from the positioning satellites, and the positioning apparatus may receive the signal produced from the positioning information offering apparatus that has selectively changed the receiving channel of this signal according to the reference stations disposed around the offering apparatus.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an embodiment of a positioning system according to the invention.

FIG. 2 is a flowchart for the operation of a positioning-information offering apparatus used in the positioning system shown in FIG. 1.

FIG. 3 is a flowchart for the positioning apparatus used in the positioning system shown in FIG. 1.

FIG. 4 shows an example of the signal transmitted from the positioning-information offering apparatus used in the positioning system shown in FIG. 1.

### DESCRIPTION OF THE EMBODIMENTS

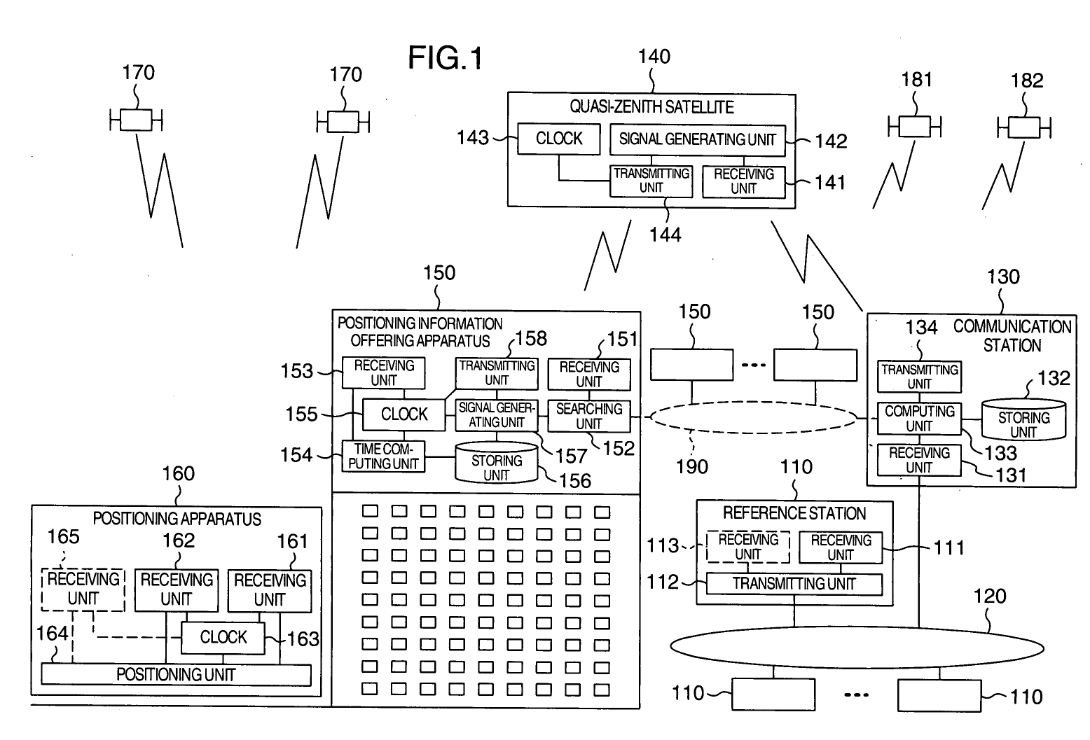

FIG. 1 is a diagram showing an embodiment of a positioning system according to the invention. In this positioning system, a positioning apparatus 160 is provided within an object to be measured in its position. This apparatus 160 thus measures the position of the object by using the signals transmitted from a plurality of GPS (Global Positioning System) satellites 170 and a quasi-zenith satellite 140 that passes around the zenith. In other words, multiple reference stations 110 located on the ground receive the signals from the GPS satellites 170, and transmit the received information to a communication station 130.

Then, the communication station 130 transmits the correction information of GPS satellites 170 to the quasi-zenith satellite 140. The quasi-zenith satellite 140 sends positioning information and correction information to a positioning-information offering apparatus 150 and the positioning apparatus 160. The positioning-information offering apparatus 150 transmits the positioning information and correction information to the positioning apparatus 160. Thus the positioning apparatus 160 can determine its own position.

More specifically, the reference stations 110 each have a GPS-satellite receiving unit 111 and a signal-transmitting unit 112. The GPS-satellite receiving unit 111 has an antenna and RF (radio frequency), a filter, an A/D converter (analog/digital converter) and so on. This GPS-satellite receiving unit 111 receives carrier waves of L1 band (1575.42±1 MHz) and L2 band (1227.6±1 MHz) sent from the GPS satellites 170. Then, it detects the positioning information of GPS satellites 170 included within the L1-band carrier, and the phases of the L1-band and L2-band carriers.

The positioning information of GPS satellites 170 includes the identification codes (pseudo noise code) of the GPS satellites 170, the time of having transmitted the carriers, and the orbit information (ephemeris) of GPS satellites 170. The detected positioning-information is transmitted together with the phase information of the L1-band and L2-band carriers to the communication station 130 via the signal transmitting unit 112 such as a modem or network card connected to a network 120 of the telephone infrastructure or Internet to which the communication station 130 is connected.

The communication station 130 has a signal receiving unit 131, an information-storing unit 132, a correction information-computing unit 133 and a transmitting unit 134. The signal-receiving unit 131 is a modem or network card, and connected to the network 120 so that it can receive the signals from the multiple reference stations 110. The information-storing unit 132 is a hard disk or memory, and has stored therein the identification codes and positions of reference stations 110 and the orbit information of the quasi-zenith satellite 140. The correction information computing unit 133 such as CPU computes the pseudo ranges from each reference station 110 to the GPS satellites 170, the correction data for the pseudo ranges, the L1-band and L2-band carrier phases, the correction data for the L1-band and L2-band carrier phases, and the GPS time of having received on the basis of the information sent from the reference stations 110 and the information stored in the information-storing unit 132. Then, it transmits the correction information of the GPS satellites 170 and the correction information of the quasi-zenith satellite 140 to the transmitting unit 134.

The correction information of the GPS satellites 170 includes the pseudo ranges from each reference station up to the GPS satellites 170 caught by each reference station 110, the correction data for the pseudo ranges, the L1-band and L2-band carrier phases, the correction data for the carrier phases, the identification codes and positions of the reference stations 110, and the GPS time of having received. The transmitting unit 134 has an antenna, a D/A converter and an amplifier, and transmits the correction information of the GPS satellites 170 and the orbit information of the quasi-zenith satellite 140 to the quasi-zenith satellite 140.

The quasi-zenith satellite 140 has a receiving unit 141, a transmission signal-generating unit 142, a clock 143, and a transmitting unit 144. This satellite 140 is located at substantially the zenith above the area over which the information is offered. The receiving unit 141 has an antenna, an A/D converter, and an amplifier, and receives the signals sent from the communication station 30 to detect the correction information of the GPS satellites 170 and the orbit information of the quasi-zenith satellite 140. The transmission signal-generating unit 142 such as CPU generates a combination signal of the positioning information of the quasi-zenith satellite 140 and the correction information of the GPS satellites 170.

The positioning information of the quasi-zenith satellite 140 includes the identification code of quasi-zenith satellite 140 that is generated in the pseudo noise code, transmission time, orbit information of quasi-zenith satellite 140. The orbit information may be replaced by the position information. The clock 143 generates time marks. The transmitting unit 144 has an antenna, a D/A converter and an amplifier, and transmits to the ground a combination signal of the positioning information of quasi-zenith satellite 140 and the correction information of GPS satellites 170.

The communication station 130 is connected through a network 190 to a plurality of positioning information offering apparatus 150. Each positioning information offering apparatus 150 has a quasi-zenith satellite receiving unit 151, a correction information searching unit 152, a GPS satellite receiving unit 153, a clock 155, a time computing unit 154, a position information storing unit 156, a transmission signal generating unit 157, and a transmitting unit 158. The quasi-zenith satellite-receiving unit 151 has an antenna, an A/D converter, and an amplifier. This quasi-zenith satellite-receiving unit 151 receives the signal sent from the quasi-zenith satellite 140 and detects the positioning information of the quasi-zenith satellite 140 and the correction information of the GPS satellites 170. The correction information-searching unit 152 such as CPU searches the information sent from the quasi-zenith satellite 140 for the correction information of each GPS satellite 170 caught by three reference stations 110 that surround the positioning information offering apparatus 150.

The GPS satellite-receiving unit 153 has an antenna and RF, a filter, and an A/D converter, and receives the L1-band carrier sent from the GPS satellites 170. Then, it detects the positioning information of the GPS satellites 170 that is included in this signal. The clock 155 generates time marks. The time computing unit 154 such as CPU computes the receiving time on the basis of the positioning information of the GPS satellites 170 that the GPS satellite receiving unit 153 has detected, and the correction information of the GPS satellites 170 that the quasi-zenith satellite receiving unit 151 has received. In addition, in order to improve the precision of the position information of the positioning information offering apparatus 150, it computes the average of the position information obtained when the positioning information offering apparatus 150 has computed the time of reception and the position information determined so far, and modifies the position information of the positioning information offering apparatus 150 that is stored in the position information storing unit 156.

The position information-storing unit 156 includes a storage device such as a hard disk or memory, and has stored therein the position information of the positioning information offering apparatus 150. The transmission signal-generating unit 157 such as CPU generates a combination signal of the correction information of each GPS satellite 170 that the correction information-searching unit 152 has detected and the positioning information of the positioning information offering apparatus 150. The positioning information of the positioning information offering apparatus 150 includes the identification code of the positioning information offering apparatus 150, the transmitting time, and the position of the positioning information offering apparatus 150. The transmitting unit 158 includes an antenna, a D/A converter, and an amplifier, and transmits a combination signal of the positioning information of the positioning information offering apparatus 150 and the correction information of the GPS satellites 170.

The positioning apparatus 160 has a positioning-information offering apparatus receiving unit 161, a GPS satellite-receiving unit 162, a clock 163, and a positioning unit 164. The positioning information offering apparatus receiving unit 161 has an antenna, an A/D converter, and an amplifier, receives the signal sent from the positioning information offering apparatus 150, and detects from this signal the correction information of the GPS satellites 170 and the positional information of the positioning information offering apparatus 150.

The GPS satellite-receiving unit 162 has an antenna and RF circuits, a filter, and an A/D converter. The GPS satellite-receiving unit 162 receives the L1-band and L2-band carriers sent from the GPS satellites 170, and detects from this signal the positioning information of the GPS satellites 170 and the phases of the L1-band and L2-band carriers. The clock 163 generates time marks. The positioning unit 164 such as CPU computes the position of the positioning apparatus 160 on the basis of the positioning information of the GPS satellites 170, the correction information of the GPS satellites 170, and the positioning information of the positioning information offering apparatus 150.

The operation procedure of the reference stations 110 used in the positioning system mentioned above will be described below. The GPS satellite-receiving unit 111 detects the positioning information of the GPS satellites 170 that is included in the L1-band radio wave from the L1-band and L2-band carriers sent from the GPS satellites 170. Also it detects the phases of the L1-band and L2-band carriers and sends the receiving time, the positioning information of the GPS satellites 170, and the phase information of the L1-band and L2-band carriers to the signal-transmitting unit 112. The signal-transmitting unit 112 transmits the receiving time, the positioning information of the GPS satellites 170, and the phase information of the L1-band and L2-band carriers to the communication station 130.

The communication station 130 operates as follows. The signal-receiving unit 131 receives the positioning information of the GPS satellites 170, the phase information of the L1-band and L2-band carriers and the receiving time that the multiple reference stations 110 have caught, and sends them to the correction-information computing unit 133. The correction information computing unit 133, on the basis of this information and the position information of reference stations 110 that is stored in the information storing unit 132, computes the pseudo ranges from each station up to the GPS satellites 170 that the respective reference stations 110 have caught, the correction data of the pseudo ranges, the phases of the L1-band and L2-band carriers, the correction data of the phases of the L1-band and L2-band carriers, and the GPS time of having received. Then, it sends to the transmitting unit 134 the identification codes and positions of reference stations 110, and the orbit information of the quasi-zenith satellite 140 that are previously stored in the information storing unit 132. The transmitting unit 134 transmits the correction information of the GPS satellites 170 caught by the reference stations 110, and the orbit information of the quasi-zenith satellite 140 to the quasi-zenith satellite 140.

The operation procedure of the quasi-zenith satellite 140 will be next described. The receiving unit 141 receives the signal sent from the communication station 130, detects from this signal the correction information of the GPS satellites 170 caught by the reference stations 110 and the orbit information of the quasi-zenith satellite 140, and sends them to the transmission signal generating unit 142. The transmission signal-generating unit 142 generates a combination signal of the identification code, orbit information and transmitting time information (positioning information of the quasi-zenith satellite 140) of the quasi-zenith satellite 140, and the correction information of the GPS satellites 170. Then, the combination signal is sent to the transmitting unit 144. The transmitting unit 144 determines the transmitting time of the signal from the transmission-signal generating unit 142 on the basis of the time marks that the clock 143 generates, and transmits it to the ground.

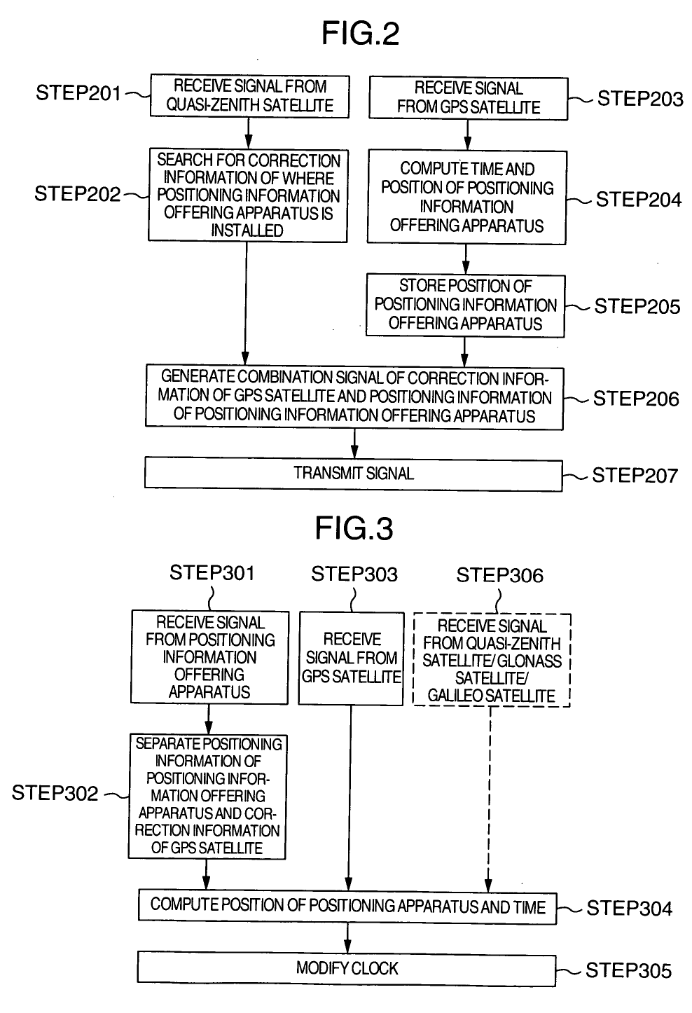

Referring to FIG. 2, description will be made of the operation procedure of the positioning information offering apparatus 150 that processes on the ground the signal transmitted from the quasi-zenith satellite 140.

The quasi-zenith receiving unit 151 detects the correction information of the GPS satellites 170 and the positioning information of the quasi-zenith satellite 140 from the signal that the quasi-zenith satellite 140 has transmitted. Then, it sends the positioning information to the correction information-searching unit 152 (step 201). Then, in step 202, the correction information searching unit 152 searches the correction information of the GPS satellites 170 in order to detect certain correction information of the GPS satellite 170 caught by three reference stations 110 that surround the area in which the positioning information offering apparatus 150 is installed. The searched result is sent to the transmission signal-generating unit 157.

On the other hand, the GPS satellite-receiving unit 153 receives the signals from the GPS satellites 170 in synchronism with the output from the clock 155. Then, it detects the positioning information of the GPS satellite 170 caught, and sends it to the time computing unit 154 (step 203). In step 204, the time computing unit 154 computes the position of the positioning information offering apparatus 150 and the receiving time on the basis of the positioning information of this GPS satellite and the correction information of the GPS satellite 170. It estimates the present time by adding the processing time to the computed receiving time, and sends it to the clock 155. In addition, it modifies the time that the clock 155 indicates on the basis of the present time estimated by the time computing unit 154. The average of the position that the positioning information offering apparatus 150 has found this time and the positions found so far is stored in the positioning information storing unit 156 as the position of the positioning information offering apparatus 150 (step 205).

The transmission signal generating unit 157 generates a combination signal of the correction information of the GPS satellite 170 searched for in step 202, the transmitting time, identification code (pseudo noise code) and position information, and the positioning information of the positioning information offering apparatus 150, and supplies it to the transmitting unit 158 (step 206). Then, in step 207, the transmitting unit 158 transmits the signal generated in step 206 to the positioning apparatus 160 in synchronism with the transmitting time that is previously determined on the basis of the time mark produced from the clock 155.

The operation procedure of the positioning apparatus 160 will be described with reference to FIG. 3.

The signal sent from the positioning information offering apparatus 150 to the positioning apparatus 160 is received by the positioning information offering apparatus receiving unit 161. At the time of the reception, the time mark generated from the clock 163 is supplied to the positioning unit 164. The positioning information offering apparatus receiving unit 161 detects from the received signal the correction information of the GPS satellites 170 caught by the three reference stations 110 that surround the area in which the positioning information offering apparatus 150 is installed, and the positioning information of the positioning information offering apparatus 150, and supplies them to the positioning unit 164 (step 301).

The positioning unit 164 separates the received information into the positioning information of apparatus 150 and the correction information of the GPS satellites 170 (step 302). On the other hand, the GPS-satellite receiving unit 162 receives the L1-band and L2-band carriers transmitted from the GPS satellites 170, detects the positioning information of the GPS satellites 170 and the phases of the L1-band and L2-band carriers, and supplies them to the positioning unit 164. In addition, the time mark generated from the clock 163 at the time of reception is supplied to the positioning unit 164 (step 303).

The positioning unit 164 uses the positioning information of the positioning information offering apparatus 150, the correction information of the GPS satellites 170, the positioning information of the GPS satellites 170 caught, and the phases of the L1-band and L2-band carriers to compute the position of the positioning apparatus 160 and the receiving time in the case when the distances between the positioning apparatus 160 and each of the positioning information offering apparatus 150 and GPS satellites 170 become nearest to the pseudo ranges. Here, the pseudo range is the product of the apparent transmission time of radio waves and the light velocity. The details of this computation will be mentioned below. The position of the positioning apparatus 160 with SA (Selective Availability) provided is computed on the basis of the positioning information of the GPS satellites 170 and the time of having received the L1-band carrier.

It is assumed that the correction data for pseudo range and phase in association with each GPS satellite 170 linearly change with respect to the longitude and latitude. The correction data d for pseudo ranges of each GPS satellite 170 at a place of longitude (x), latitude (y) with respect to three reference stations 110 are placed on the same plane. This plane can be expressed by a linear relation of equation (1). Here, coefficients a1˜a3 are computed from the longitude and latitude of the three reference stations 110 and the correction data for the pseudo range of each GPS satellite 170.

d=a1·x+a2·y+a3 (1)

The correction data for the pseudo range at that time is calculated by substituting the position (longitude, latitude) of positioning apparatus 160 into the equation (1). The correction data for the phases of the L1-band and L2-band carriers is also computed considering that they linearly change. The pseudo range is corrected on the basis of the computed correction data, and the position of the positioning apparatus 160 and the receiving time are computed. The pseudo range with respect to the positioning information offering apparatus 150 is also found from the product of the transmission time and the light velocity (step 304). Then, the time that the clock 163 indicates is modified on the basis of the receiving time calculated by the positioning unit 164 (step 305).

The pseudo range computation in step 304 may use various methods such as the Multi-Reference Station proposed by the Calgary University, Referenz Netz used in Geo ++ satellite, and Virtual Reference Station used in Trra Sat satellite.

In step 304, when the GPS time received by the positioning apparatus 160 is 10 seconds faster than that received by the reference stations 110 that is included in the correction information of the GPS satellites 170, the position of the positioning apparatus 160 is employed that is computed from the positioning information of the GPS satellite 170 and the phases of the L-band and L2-band carriers in place of the correction information of the GPS satellite 170. This is why the precision improvement cannot be expected by the correction.

The correction information of the GPS satellite 170 caught by more than three reference stations 110 can also be detected in place of the search for the correction information of the GPS satellites 170 caught by the three reference stations 110 that surround the positioning information offering apparatus 150, and transmitted for the positioning. At this time, the positioning apparatus 160 computes the coefficients a1˜a3 of the equation (1) by using the method of least squares.

In this embodiment, since the correction information of the GPS satellites 170 caught by three reference stations 110 is searched for and transmitted, it is possible to more reduce the amount of data traffic from the positioning information offering apparatus 150 to the positioning apparatus 160 than by transmitting the correction information of the GPS satellites 170 caught by all the reference stations 110 in Japan. Thus the amount of processing in the positioning information offering apparatus 150 and poisoning apparatus 160 can be lowered, and hence the apparatus cost can be cut down.

If the correction information of the GPS satellites caught by three reference stations, which is transmitted from the positioning information offering apparatus 150, is changed to that obtained at the position of the positioning information offering apparatus 150 or at the center of the place from which the positioning information offering apparatus 150 transmits the signal, the amount of data capacity can be reduced to ⅓ as small as in the case to the contrary. Because of the reduced data capacity, it is possible to decrease the amount of processing in the positioning information offering apparatus 150 and positioning apparatus 160. The poisoning information offering apparatus 150 finds the correction information from the equation (1). The positioning apparatus 160 corrects the pseudo ranges and phases by using the transmitted correction information.

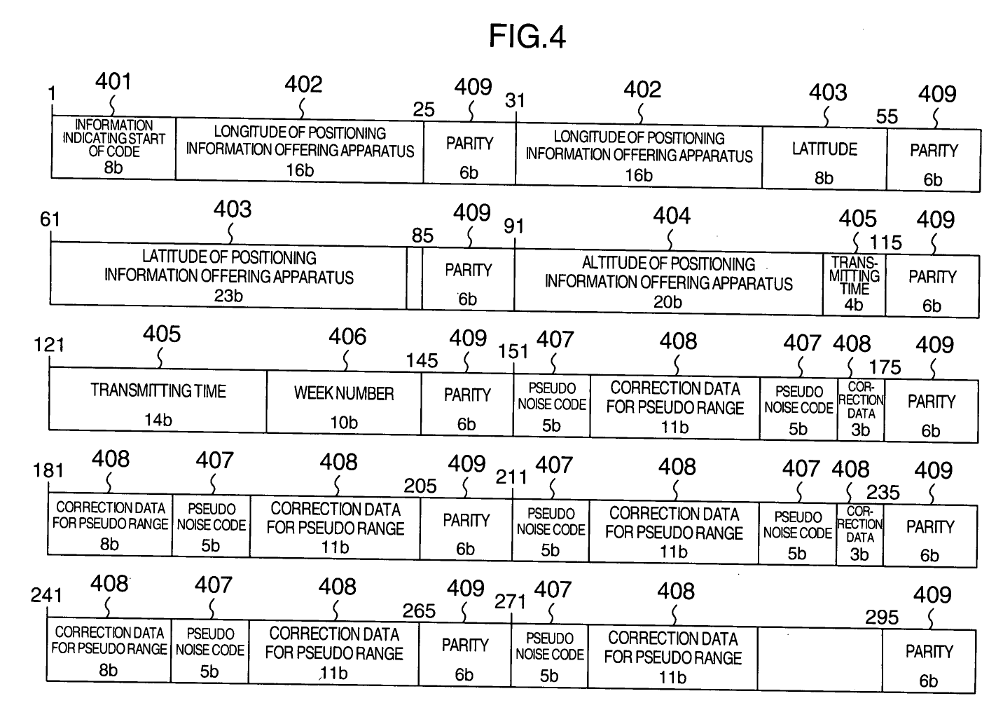

FIG. 4 shows an example of the signal transmitted from the positioning information offering apparatus 150. This signal has the same L1-band frequencies and format as the GPS signal, and it is the sub frame of the navigation message of the GPS signal. Thus the positioning apparatus 160 can receive the correction information of the GPS satellites 170 at every six seconds.

The signal shown in FIG. 4 includes information 401 that indicates the start of codes, the longitude 402, latitude 403 and altitude 404 of the positioning information offering apparatus 160, transmitting time 405, transmitted week number 406, pseudo noise codes (identification codes) 407 of seven GPS satellites 170 at the position of the positioning information offering apparatus 150 or at the center of the place from which the positioning information offering apparatus 150 transmits the signal, and correction data 408 for the pseudo ranges.

The position of positioning information offering apparatus 150 can be expressed in the order of centimeters by using its longitude 404 of 32 bits, latitude 403 of 31 bits, and altitude 404 (for 10,000 meter above the surface of the earth) of 20 bits. As to the transmitting time, the week number 406 of 10 bits is expressed relative to Jan. 6^{th}, 1980, and the transmitting time 405 of 18 bits is expressed in units of 6 seconds after the start of each week. Since all the pseudo noise codes of the GPS satellites 170 can be expressed in 5 bits, the range of ±50 m can be expressed in units of 5 cm by using the correction data 408 of 11 bits for the pseudo ranges.

When the reference stations 110 near the positioning information offering apparatus 150 catche more than seven GPS satellites 170, only seven GPS satellites can be selected. At this time, if the GPS satellites 170 selected are near the zenith around which the reference stations 110 are easy to catch, there is a high possibility that the positioning apparatus 160 can also caught, and thus the positioning precision can be improved. The parity 409 of 6 bits is used to check the information of 24 bits that is transmitted before the parity 409.

According to this embodiment, either one of the positioning information offering apparatus receiving unit 161 and GPS satellite receiving unit 162 can be shared by the other. The positioning information offering apparatus 150 corresponds to a pseudo satellite that transmits a pseudo GPS signal. The positioning apparatus 160 makes positioning by the differential system.

In this embodiment, the positioning can be made with high precision by using the correction information of at least any one (hereinafter, simply called positioning satellite 200) of GLONASS satellite 181, GALILEO satellite 182, and quasi-zenith satellite 140 as a positioning satellite other than the GPS satellites 170. Specifically, the receiving unit 113 for the positioning satellite 200 is provided in the reference stations 110 to detect the positioning information that includes the identification codes, orbits and transmitting time marks of the satellites. Then, the correction information computing unit 133 of the communication station 130 computes the pseudo ranges from the positioning information of positioning satellites 200, and finds the differences to the pseudo ranges estimated from the positions of reference stations 110 stored in the information storing unit 132 as the correction data for the pseudo ranges. The communication station 130 and the quasi-zenith satellite 140 transmit the correction information of GPS satellites 170 and also the correction information of positioning satellites 200.

The positioning information offering apparatus 150 searches the signal received from the quasi-zenith satellites 140 for the correction information of positioning satellites 200 and GPS satellites caught by three or more reference stations 110 near the positioning information offering station 150. Then, a combination of this correction information and the positioning information of the positioning information offering apparatus 150 is transmitted to the positioning apparatus 160.

A receiving unit 165 for positioning satellites 200 is added to the positioning apparatus 160 so that the apparatus can receive the positioning information of the positioning satellites 200 (see step 306 in FIG. 3). Then, the pseudo ranges are corrected according to the correction information of GPS satellites 170 and the correction information of positioning satellites 200 transmitted from the positioning information offering apparatus 150. The same method as in step 304 in FIG. 3 is used to synchronize and compute the position of the positioning apparatus 160.

If the correction information of positioning satellites 200 transmitted from the positioning information offering apparatus 150 is changed, to that resulting from applying the equation (1) to correct the correction information obtained at the position of the positioning information offering apparatus 150 or at the center of the place from which this apparatus transmits, from that of the satellites caught by three reference stations 110 that surround the positioning information offering apparatus 150, the data capacity can be reduced to ⅓ as small as in the case to the contrary. Therefore, the amount of data traffic from the positioning information offering apparatus 150 to the positioning apparatus 160 can be lowered, and hence the amount of processing in the positioning information offering apparatus 150 and positioning apparatus 160 can be cut down.

According to this embodiment, since the communication station 130 and the positioning information offering apparatus 150 are connected by the network 190, the correction information of the GPS satellites 170 and positioning satellites 200 that is transmitted from the quasi-zenith satellite 140 can be received through the network 190 even if this correction information cannot be received from the quasi-zenith satellite 140, and thus the correction information can be transmitted stably and continuously.

In this embodiment, if the GPS satellite receiving unit 162 of positioning apparatus 160 is used as a unit for receiving the L1-band carrier from the GPS satellites 170 and detecting the positioning information of GPS satellites 170, and if the positioning unit 164 is used as a unit for computing the correction data for the pseudo ranges at the position of the positioning apparatus 160 from the equation (1), correcting the pseudo ranges from the GPS satellites 170 to that position on the basis of that correction data and computing the position of positioning apparatus 160 (differential system), then the positioning precision can be improved more than by point positioning since the correction information is used. In addition, since the receiver for L2-band is not necessary, the cost can be reduced more than the apparatus capable of receiving the L2-band carrier in addition to L1-band.

This embodiment employs SS (Spread Spectrum) for the transmission system of the transmitting unit 144 that the quasi-zenith satellite 140 has. Therefore, the transmission signal-generating unit 142 divides the correction information of each reference station 110 into groups for areas according to the channel number of the spread spectrum. The groups of the correction information are transmitted from the transmitting unit 144 to the positioning information offering apparatus 150 and to the positioning apparatus 160. These apparatus 150, 160 selectively receive channels of quasi-zenith satellite 140 in dependence upon their own positions. Therefore, the interval in which the correction information is transmitted becomes short, and as a result the correction information can be received in a short time.

The positioning precision is more degraded as the time from when the reference stations 110 receive to when the positioning apparatus 160 makes positioning becomes long. Thus, in this embodiment, the correction information of each reference station 110 is divided into groups for respective areas. The quasi-zenith satellite 140 transmits correction information. Thus, the time taken to transmit the correction information can be reduced so that the positioning precision can be improved. In addition, since the amount of data traffic to the positioning information offering apparatus 150 and positioning apparatus 160 can be lowered to decrease the amount of processing in those apparatus 150, 160, so that the apparatus cost can be cut down.

In the positioning information offering apparatus 150, the frequency bands of 2.4 GHz and 5 GHz that are used for cell phone and personal digital assistant (PDA) are employed to transmit the correction information of GPS satellites 170 and the positioning information of the positioning information offering apparatus 150. Therefore, if the function of positioning apparatus 160 is incorporated in the cell phone or PDA that has a radio LAN facility, the apparatus can be small-sized, and thus the apparatus cost can be reduced.

If the correction information of GPS satellites 170 is transmitted in a form of RTCM ver. 3.0, three reference stations 110 each catch 12 GPS satellites 170, and as a result the amount of data is 4446 bits. If it is transmitted in a form of IEEE 802.11, the transmission speed of 2.4-GHz band frequencies is 1 Mbps/2Mbps, and the transmission area is 100×100 m. Therefore, the correction information of GPS satellites 170 can be transmitted every second. When the frequency band is 5 GHz, the form of IEEE 802.11a is used. Since the transmission speed is a maximum of 54 Mbps, the correction information of GPS satellites 170 can also be transmitted every second. In addition, if the IS-95 form of CDMA system is used for mobile communication such as cell telephone, the transmission speed is 9.6 kbps. In this case, too, the correction information of GPS satellites 170 can be transmitted every second.

According to this embodiment, since the positioning information offering apparatus as auxiliary receiving and transmitting means can be installed at the position where the signals from the positioning satellites have so far been prevented from being received, the number of areas in which the positioning is disturbed can be decreased. In addition, since the positioning information offering apparatus can be disposed at a place convenient to receive from a plurality of positioning satellites, the precision and reliability of the positioning can be improved.

According to the invention, since the positioning information is corrected on the basis of the information from an auxiliary receiving unit that is provided to be capable of receiving the positioning information of a plurality of positioning satellites, the number of areas in which the positioning is disturbed can be reduced, and the positioning can be made with high precision. In addition, since the correction information of the positioning satellites caught by three reference stations is transmitted from the positioning information offering apparatus to the positioning apparatus, the amount of correction information traffic to the positioning apparatus and positioning information offering apparatus can be lowered, and thus the apparatus cost can be cut down.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A positioning system for offering positioning information on the basis of a signal transmitted from a quasi-zenith satellite, wherein said signal includes another signal transmitted to said quasi-zenith satellite from a communication station after being produced as a result of processing still other signals received from a plurality of positioning satellites by multiple reference stations placed on the ground, and a positioning information offering apparatus is provided to transmit said signal sent from said quasi-zenith satellite and a positioning information of said positioning system.

2. A positioning system according to claim 1, wherein said signal transmitted from said communication station includes at least a signal resulting from processing the signals that three ones surrounding said positioning information offering apparatus, of said multiple reference stations, have transmitted, and the positioning information of said positioning information offering apparatus includes its own identification code, transmitting time, and its own position or position at the time of transmission.

3. A positioning system according to claim 1, wherein the frequency of said signal transmitted from said quasi-zenith satellite is different from that of said signal transmitted from said positioning information offering apparatus.

4. A positioning system according to claim 2, wherein the frequency of said signal transmitted from said quasi-zenith satellite is different from that of said signal transmitted from said positioning information offering apparatus.

5. A positioning system according to claim 3, wherein said signal transmitted from said positioning information offering apparatus is of 2.4-GHz band, 5-GHz band or a frequency band for mobile communication.

6. A positioning system according to claim 4, wherein said signal transmitted from said positioning information offering apparatus is of 2.4-GHz band, 5-GHz band or a frequency band for mobile communication.

7. A positioning system connected via a network to a communication station that offers positioning information, wherein a positioning information offering apparatus is provided to transmit a positioning information of said positioning system and other positioning information that is offered from said communication station after being produced by processing the signals received from a plurality of positioning satellites by multiple reference stations.

8. A positioning system for offering positioning information on the basis of a signal transmitted from a quasi-zenith satellite, wherein said signal includes another signal transmitted to said quasi-zenith satellite after being produced as a result of processing still other signals received at multiple places from a plurality of positioning satellites, and a positioning apparatus is provided to detect a position of said positioning system by receiving a composite signal from a positioning information offering apparatus that is placed on the ground to combine said signal sent from said quasi-zenith satellite and its own positioning information and to transmit said composite signal.

9. A positioning system according to claim 1, wherein said multiple positioning satellites include at least any one of GPS satellite, GLONASS satellite, GALILEO satellite and quasi-zenith satellite.

10. A positioning system according to claim 8, wherein said multiple positioning satellites include at least any one of GPS satellite, GLONASS satellite, GALILEO satellite and quasi-zenith satellite.

11. A positioning system according to claim 1, wherein said signal transmitted from said quasi-zenith satellite has its transmission channel changed according to the reference stations that have received signals from said positioning satellites.

12. A positioning system according to claim 11, wherein said positioning information offering apparatus selectively changes the receiving channel of said signal transmitted from said quasi-zenith satellite according to the reference stations disposed around said apparatus.

13. A positioning system according to claim 8, wherein said signal transmitted from said quasi-zenith satellite changes the transmission channel according to the reference stations that have received the signals from said positioning satellites, and said positioning apparatus receives the signal produced from said positioning information offering apparatus that has selectively changed the receiving channel of said signal according to the reference stations disposed around said positionig information offering apparatus.

14. A positioning information offering method for offering positioning information on the basis of a signal transmitted from a quasi-zenith satellite, wherein said signal includes another signal transmitted to said quasi-zenith satellite from a communication station after being produced as a result of processing still other signals received from a plurality of positioning satellites by multiple reference stations placed on the ground, and a positioning information offering apparatus is provided to transmit said signal sent from said quasi-zenith satellite and a positioning information of said positioning system.

15. A positioning information offering method comprising the steps of:
receiving positioning-information by an apparatus from a communication station after processing signals received by a plurality of reference stations from multiple positioning satellites; and transmitting said positioning information and other positioning information of said apparatus.

16. A positioning information offering method for offering positioning information on the basis of a signal transmitted from a quasi-zenith satellite, wherein said signal includes another signal transmitted to said quasi-zenith satellite after being produced as a result of processing still other signals received at multiple places from a plurality of positioning satellites, and a positioning apparatus is provided to detect position by receiving a composite signal from a positioning information offering apparatus that is placed on the ground to combine said signal sent from said quasi-zenith satellite and positioning information and to transmit said composite signal.
